(19) United States
(12) Patent Application Publication
(10) Pub. No.: US 2023/0328776 A1
(43) Pub. Date: Oct. 12, 2023

(54) WIRELESS COMMUNICATION METHOD AND WIRELESS COMMUNICATION DEVICE

(71) Applicant: NIPPON TELEGRAPH AND TELEPHONE CORPORATION, Tokyo (JP)

(72) Inventors: Shoko SHINOHARA, Musashino-shi, Tokyo (JP); Yusuke ASAI, Musashino-shi, Tokyo (JP); Yasushi TAKATORI, Musashino-shi, Tokyo (JP); Yasuhiko INOUE, Musashino-shi, Tokyo (JP); Mitsuki NAKAMURA, Musashino-shi, Tokyo (JP)

(73) Assignee: NIPPON TELEGRAPH AND TELEPHONE CORPORATION, Tokyo (JP)

(21) Appl. No.: 18/023,626

(22) PCT Filed: Sep. 2, 2020
(86) PCT No.: PCT/JP2020/033230

§ 371 Date: Feb. 27, 2023

(51) Int. Cl. H04W 74/08

(52) U.S. Cl. CPC H04W 74/0808

(57) ABSTRACT

A wireless communication method in a wireless communication system includes carrier sense processing for determining whether a carrier sense band is in a busy state or an idle state on the basis of a reception state of a reception signal in the carrier sense band before transmitting a transmission signal using a transmission channel. The carrier sense band is set so as to include not only a transmission channel band which is a frequency band of a transmission channel but also an adjacent carrier sense band adjacent to the transmission channel band. When it is determined that the carrier sense band is in an idle state, transmission processing for transmitting a transmission signal by using a transmission channel is performed.

### TECHNICAL FIELD

The present invention relates to a wireless communication technology. In particular, the present invention relates to a wireless communication technique for performing carrier sense processing before starting communication.

### BACKGROUND ART

In unlicensed band, in particular, in the 2.4 GHz band and the 5 GHz band, the practical standard of the communication standard prescribed in IEEE802.11 is Wireless LAN (Local Area Network).

FIG. 1 shows a channel configuration of the 2.4 GHz band. FIG. 2 shows a channel configuration of the 5 GHz band. The frequency band allocated to each channel is predetermined. A channel that the wireless communication device desires to use at the time of signal transmission is hereinafter referred to as “transmission channel”. The frequency band of the transmission channel is hereinafter referred to as “transmission channel band TCB”.

FIG. 1 conceptually shows a transmission spectrum mask for each transmission channel.

FIG. 3 shows an example of a transmission spectrum mask when the channel size is 20 MHz. The transmission spectrum mask defines a distribution of power spectrum density that is allowed for a transmission signal. In the example shown in FIG. 3, the center frequency band (main lobe) of 20 MHz width including the center frequency fc of the transmission channel corresponds to the transmission channel band TCB. A frequency band adjacent to the transmission channel band TCB (side lobe), is a leakage band LB. The spectrum mask is prescribed in a band of the total 60 MHz width including leak band LB and transmission channel band TCB. As shown in FIG. 3, the power spectrum density in the leakage band LB must be reduced by a predetermined level or more than the power spectrum density in the transmission channel band TCB.

In the Wireless LAN, a plurality of wireless communication devices for performing wireless communication using the same frequency band coexist. In this case, it is important to suppress collision between transmission signals from a plurality of wireless communication devices. Therefore, in the Wireless LAN, a communication method called CSMA/CA (Carrier Sense Multiple Access with Collision Avoidance) is adopted.

According to CSMA/CA, each wireless communication device executes “carrier sense processing” for determining whether a desired transmission channel is in a busy state (in use) or in an idle state (in non-use state) before starting signal transmission. More specifically, the wireless communication device monitors the reception state of the reception signal in the transmission channel band TCB for a fixed time. When the reception power exceeds a predetermined carrier sense threshold, the wireless communication device determines that the transmission channel (transmission channel band TCB) is in a busy state, and refrains signal transmission. On the other hand, when the reception power is equal to or less than the predetermined carrier sense threshold, the wireless communication device determines that the transmission channel (transmission channel band TCB) is in an idle state, and starts signal transmission. In this way, each wireless communication device executes the carrier sense processing, so that collision of transmission signals from a plurality of wireless communication devices coexisting in the same frequency band can be autonomously suppressed.

Note that, the time required for the carrier sense processing and the carrier sense threshold are unified for each Wireless LAN standard.

When a new Wireless LAN standard is established, a carrier sense function corresponding to the new Wireless LAN standard is specified. For example, in IEEE802.11n, channel bonding becomes possible, and not only a channel of 20 MHz width, but also a channel of 40 MHz width, which is a combination of adjacent primary and secondary channels, can be used. When the transmission channel width is 40 MHz width, carrier sense processing is performed on both the primary channel and the secondary channel. When the primary channel is in an idle state and the secondary channel is in a busy state, the transmission channel is reduced only to the primary channel. In IEEE802.11ac, the maximum channel width is extended to 160 Mhz width.

In IEEE802.11ax, OFDMA (Orthogonal Frequency Division multiple Access) is introduced (refer to NPL 2). In this case, the primary channel and the secondary channel may not necessarily be adjacent to each other.

FIG. 4 shows the channel configuration of the 920 MHz band, which is also an unlicensed band. In IEEE802.11ah, a Wireless LAN using the 920 MHz band is prescribed (refer to NPL 3). In the 920 MHz band, each channel is delimited at every 0.2 MHz, but according to IEEE802.11ah, the minimum channel width is 1 MHz. Therefore, a transmission channel of 1 MHz width obtained by bundling five channels is used.

### CITATION LIST

### Non Patent Literature

[NPL 1] IEEE Standard for Information technology—Telecommunications and information exchange between systems Local and metropolitan area networks—Specific requirements, Part 11: Wireless LAN Medium Access Control (MAC) and Physical Layer (PHY) Specifications, in IEEE Std 802.11-2016 (Revision of IEEE Std 802.11-2012), 14 Dec. 2016.
[NPL 2] IEEE Draft Standard for Information Technology—Telecommunications and information exchange between systems Local and metropolitan area networks—Specific Requirements, Part 11: Wireless LAN Medium Access Control (MAC) and Physical Layer (PHY) Specifications, Amendment Enhancements for High Efficiency WLAN, in IEEE P802.11ax/D6.0, January 2020.
[NPL 3] IEEE Standard for Information technology—Telecommunications and information exchange between systems Local and metropolitan area networks—Specific requirements, Part 11: Wireless LAN Medium Access Control (MAC) and Physical Layer (PHY) Specifications, Amendment 2: Sub 1 GHz License Exempt Operation, in IEEE Std 802.11ah-2016 (Amendment to IEEE Std 802.11-2016, as amended by IEEE Std 802.11ai-2016), December 2016.

### SUMMARY OF INVENTION

### Technical Problem

The frequency band in which the reception state of the reception signal is monitored in the above-described carrier sense processing is hereinafter referred to as “carrier sense band”. As described above, the conventional carrier sense band coincides with the transmission channel band TCB which is the frequency band of the desired transmission channel. However, such a conventional technique is not necessarily sufficient from the viewpoint of interference suppression.

FIG. 5 is a conceptual diagram for explaining an example of interference occurrence when a conventional carrier sense band is used. Consider a case where the transmission signal SB is transmitted in a state where the preceding signal SA is being transmitted. The transmission channel band TCB of the transmission signal SB is not overlapped with the transmission channel band of the preceding signal SA. However, the spectrum of the preceding signal SA and the spectrum of the transmission signal SB are partially overlapped. The relationship between the preceding signal SA and the transmission signal SB is, for example, the same as the relationship between the channel 1 and the channel 6 in FIG. 1.

Before transmission of the transmission signal SB, carrier sense processing is performed on a conventional carrier sense band which coincides with the transmission channel band TCB.

Since the carrier sense band is not overlapped with the transmission channel band of the preceding signal SA, there is a high possibility that the transmission channel of the transmission signal SB is determined to be in an idle state. When it is determined that the transmission channel is in an idle state, a transmission signal SB is also transmitted during transmission of the preceding signal SA.

However, actually, the transmission channel band TCB of the transmission signal SB overlaps with the leakage band of the preceding signal SA. Therefore, the leakage power caused by the preceding signal SA affects the transmission channel band TCB of the transmission signal SB. Further, thermal noise in the wireless communication apparatus also affects the transmission channel band TCB. That is, a certain degree of interference occurs with the transmission signal SB in the transmission channel band TCB. This causes deterioration of the communication quality of the transmission signal SB. For example, an error rate in a wireless communication device receiving the transmission signal SB increases due to interference.

At the same time, the leakage band LB of the transmission signal SB overlaps with the transmission channel band of the preceding signal SA. Therefore, the leakage power caused by the transmission signal SB affects the transmission channel band of the preceding signal SA. Further, thermal noise in the wireless communication apparatus also affects the transmission channel band of the preceding signal SA. In other words, a certain degree of interference occurs with the preceding signal SA. This causes deterioration of the communication quality of the preceding signal SA. For example, an error rate in a wireless communication device receiving the preceding signal SA increases due to interference.

As described above, when the conventional carrier sense band is used in the carrier sense processing, there is a possibility that the communication quality of both the preceding signal SA and the transmission signal SB is deteriorated due to interference.

FIG. 6 is a conceptual diagram for explaining another example of interference generation when a conventional carrier sense band is used. In the example shown in FIG. 6, the preceding signal SA and the transmission signal SB which coexist in the same frequency band are wireless signals according to different wireless communication standards. The bandwidth of the transmission spectrum of the preceding signal SA is relatively narrow, and the bandwidth of the transmission spectrum of the transmission signal SB is relatively wide. As a result of the carrier sense processing, it is determined that the transmission channel of the transmission signal SB is in an idle state. However, the leakage band LB of the transmission signal SB includes the transmission channel band of the preceding signal SA. Therefore, the leakage power caused by the transmission signal SB affects the transmission channel band of the preceding signal SA. This causes deterioration in the communication quality of the preceding signal SA.

FIG. 7 is a conceptual diagram for explaining still another example of interference generation when a conventional carrier sense band is used. In the example shown in FIG. 7, the transmission channel band TCB of the transmission signal SB and the transmission channel band of the preceding signal SA are partially overlapped. Even in this case, there is a possibility that the transmission channel band TCB of the transmission signal SB is determined to be in an idle state depending on the overlap ratio or the transmission power of the preceding signal SA. When it is determined that the transmission channel is in an idle state, a transmission signal SB is also transmitted during transmission of the preceding signal SA. As a result, the communication quality of both the preceding signal SA and the transmission signal SB is deteriorated.

One object of the present invention is to provide a technology capable of improving communication quality by suppressing interference, in a wireless communication technology for performing carrier sense processing before starting communication.

### Solution to Problem

A first aspect of the present invention relates to an wireless communication method in an wireless communication system.

The wireless communication method includes:
a carrier sense processing in which it is determined whether the carrier sense band is in a busy state or an idle state on the basis of a reception state of a reception signal in the carrier sense band, before transmitting a transmission signal using a transmission channel;
and a transmission processing in which a transmission signal is transmitted by using a transmission channel when it is determined that the carrier sense band is in an idle state. The carrier sense band is set so as to include not only a transmission channel band which is a frequency band of a transmission channel but also an adjacent carrier sense band adjacent to the transmission channel band.

A second aspect of the present invention relates to an wireless communication device in an wireless communication system.

The wireless communication device includes:
a carrier sense processing unit which determines whether a carrier sense band is in a busy state or an idle state on the basis of a reception state of a reception signal in the carrier sense band before transmitting a transmission signal by using a transmission channel, before transmitting a transmission signal using a transmission channel;
and a transmission processing unit which transmits a transmission signal by using the transmission channel when it is determined that the carrier sense band is in an idle state. The carrier sense processing unit sets a carrier sense band so as to include not only a transmission channel band that is a frequency band of a transmission channel but also an adjacent carrier sense band adjacent to the transmission channel band.

### Advantageous Effects of Invention

According to the present invention, a carrier sense band for carrier sense processing is set so as to include not only a transmission channel band but also an adjacent carrier sense band adjacent to the transmission channel band. Thus, interference in the wireless communication system is suppressed, and communication quality is improved.

### BRIEF DESCRIPTION OF DRAWINGS

FIG. 1 is a conceptual diagram showing a channel configuration in a 2.4 GHz band.

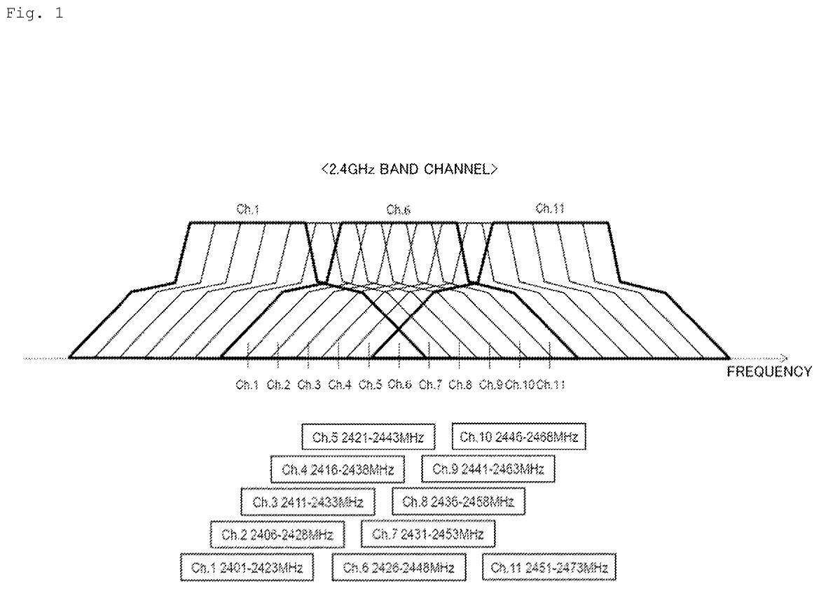

FIG. 2 is a conceptual diagram showing a channel configuration in a 5 GHz band.

FIG. 3 is a conceptual diagram showing an example of a transmission spectrum mask.

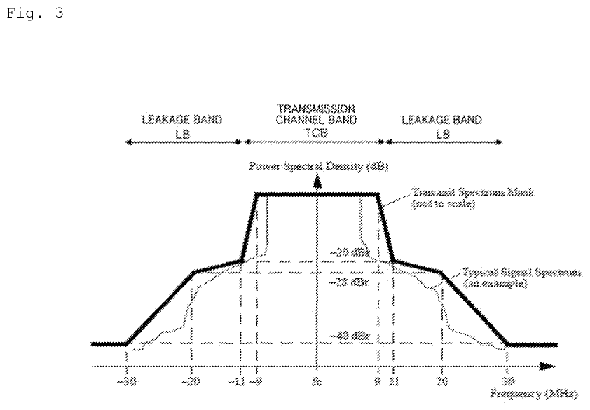

FIG. 4 is a conceptual diagram showing a channel configuration in a 920 MHz band.

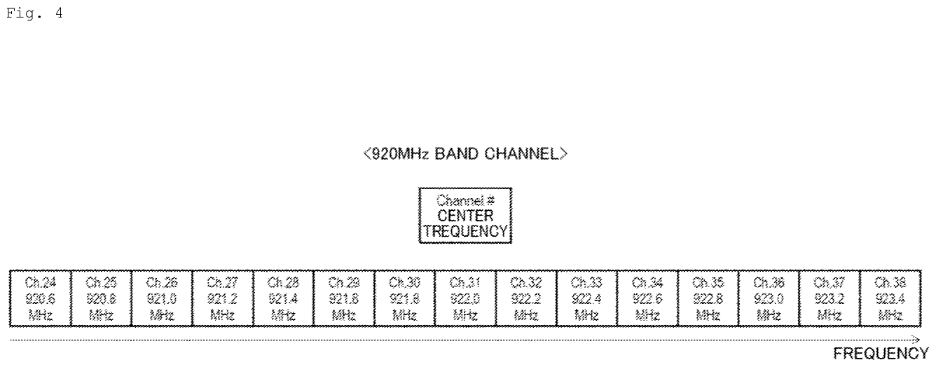

FIG. 5 is a conceptual diagram for explaining an example of interference occurrence when using a conventional carrier sense band.

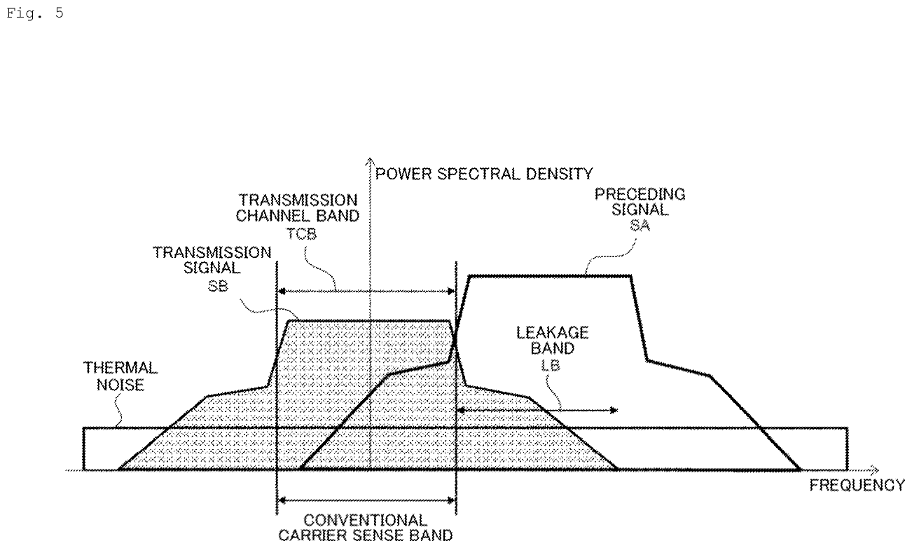

FIG. 6 is a conceptual diagram for explaining another example of interference occurrence when using a conventional carrier sense band.

FIG. 7 is a conceptual diagram for illustrating still another example of interference occurrence when using a conventional carrier sense band.

FIG. 8 is a conceptual diagram showing an example of a configuration of a wireless communication system according to an embodiment of the present invention.

FIG. 9 is a block diagram illustrating a configuration of a wireless communication device according to an embodiment of the present invention.

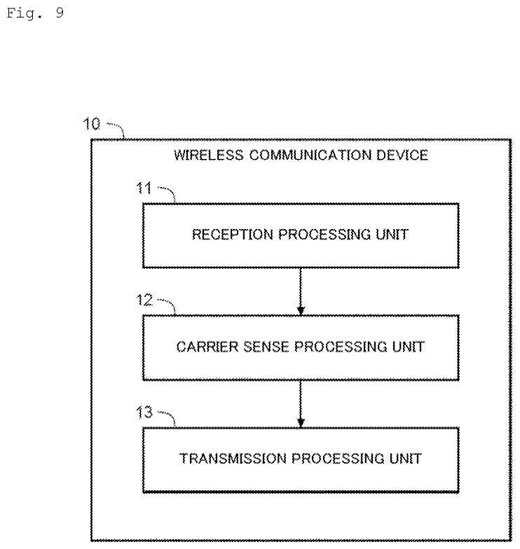

FIG. 10 is a conceptual diagram for explaining an overview of carrier sense processing according to an embodiment of the present invention.

FIG. 11 is a flowchart illustrating an example of carrier sense processing according to an embodiment of the present invention.

FIG. 12 is a flowchart illustrating another example of carrier sense processing according to an embodiment of the present invention.

FIG. 13 is a conceptual diagram for explaining the first example of carrier sense band according to an embodiment of the present invention.

FIG. 14 is a conceptual diagram for explaining the second example of carrier sense band according to an embodiment of the present invention.

FIG. 15 is a conceptual diagram for explaining the third example of carrier sense band according to an embodiment of the present invention.

FIG. 16 is a conceptual diagram for explaining the fourth example of carrier sense band according to an embodiment of the present invention.

FIG. 17 is a conceptual diagram for explaining an overview of divided carrier sense processing according to an embodiment of the present invention.

FIG. 18 is a flowchart illustrating an example of carrier sense processing including divided carrier sense processing according to an embodiment of the present invention.

FIG. 19 is a flowchart illustrating another example of carrier sense processing including divided carrier sense processing according to an embodiment of the present invention.

FIG. 20 is a conceptual diagram for explaining an example of divided carrier sense band according to an embodiment of the present invention.

FIG. 21 is a conceptual diagram for explaining another example of divided carrier sense band according to an embodiment of the present invention.

FIG. 21 is a conceptual diagram for explaining another example of divided carrier sense band according to an embodiment of the present invention.

### DESCRIPTION OF EMBODIMENTS

An embodiment of the present invention is described below with reference to the attached drawings.

### 1. System Configuration

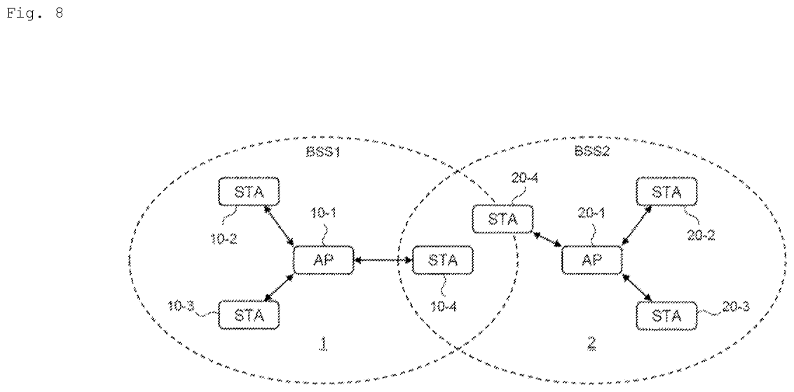

FIG. 8 is a conceptual diagram showing an example of a configuration of a wireless communication system 1 according to the present embodiment. The wireless communication system 1 performs wireless communication by using an unlicensed band. Typically, the wireless communication system 1 is a Wireless LAN system.

The wireless communication system 1 includes a plurality of wireless communication devices 10 for performing wireless communication. In the example shown in FIG. 8, the wireless communication system 1 includes wireless communication devices 10-1 to 10-4. For example, the wireless communication device 10-1 is an access point of a Wireless LAN. The wireless communication device 10-2 to 10-4 is a wireless communication terminal for communicating with an access point.

A plurality of wireless communication systems may be mixed and share the same frequency resource. For example, as shown in FIG. 8, another wireless communication system 2 may be present in the vicinity of the wireless communication system 1. The wireless communication system 2 may perform wireless communication using the same frequency band as the wireless communication system 1. The wireless communication standards of the wireless communication system 1 and the wireless communication system 2 may be the same or different.

The wireless communication system 2 includes a plurality of wireless communication devices 20 for performing wireless communication. In the example shown in FIG. 8, the wireless communication system 2 includes wireless communication devices 20-1 to 20-4. For example, the wireless communication device 20-1 is an access point of a Wireless LAN. The wireless communication device 20-2 to 20-4 is a wireless communication terminal for communicating with an access point.

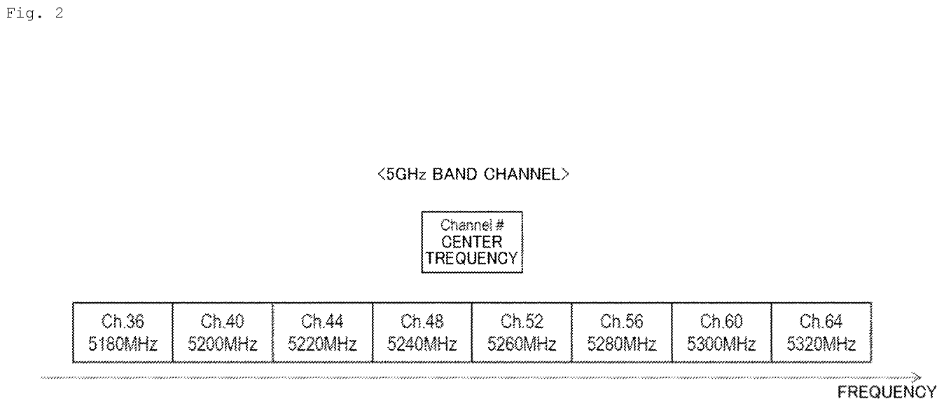

FIG. 2 is a block diagram showing a configuration of the wireless communication device 10 according to the present embodiment. The wireless communication device 10 includes a reception processing unit 11, a carrier sense processing unit 12, and a transmission processing unit 13. The reception processing unit 11 receives a wireless signal. The transmission processing unit 13 transmits a wireless signal.

A carrier sense processing unit 12 performs carrier sense processing according to CSMA/CA or the like before starting signal transmission. A frequency band to be subjected to the carrier sense processing in this embodiment is hereinafter referred to as “carrier sense band CS”. The carrier sense band CS will be described in detail later. In carrier sense processing, a carrier sense processing unit 12 monitors a reception state of a reception signal in a carrier sense band CS for a fixed time on the basis of a reception result of the wireless signal by the reception processing unit 11. Then, the carrier sense processing part 12 determines whether the carrier sense band CS is in a busy state (in use) or in an idle state (in non-use state), based on the reception state of the reception signal in the carrier sense band CS.

When it is determined that the carrier sense band CS is in an idle state as a result of the carrier sense processing, a transmission processing part 13 performs transmission processing for transmitting a transmission signal by using a desired transmission channel.

The reception processing unit 11 includes an antenna and a reception signal processing circuit. The transmission processing unit 13 includes an antenna and a transmission signal processing circuit. The carrier sense processing unit 12 is realized by an information processing device which executes various information processing. The information processing device includes, for example, a computer including a processor and a memory. The processor 11 is, for example, a CPU (Central Processing Unit). As the memory, a volatile memory and a non-volatile memory are exemplified. The function of the information processing device is realized by the processor executing a computer program stored in the memory.

Hereinafter, the wireless communication system 10 according to the present embodiment is described in more detail.

### 2. Carrier Sense Processing

### 2-1. Outline

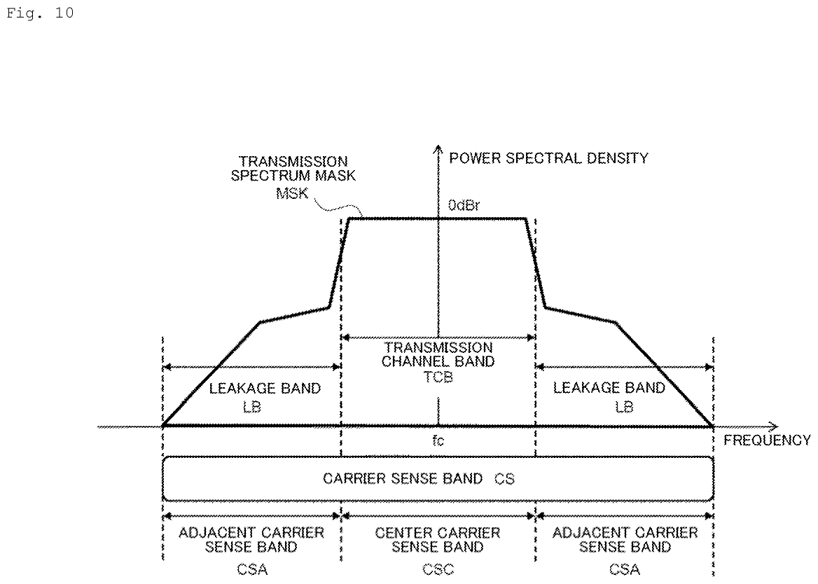

FIG. 10 is a diagram for explaining an overview of carrier sense processing according to the present embodiment. FIG. 10 shows a transmission spectrum mask MSK used in the wireless communication system 1. The transmission spectrum mask MSK prescribes a distribution of allowable power spectrum densities for the transmission signal.

The transmission channel is a channel that the wireless communication device 10 desires to use at the time of signal transmission. The transmission channel band TCB is a frequency band of a transmission channel. As shown in FIG. 10, the center frequency band including the center frequency fc of the transmission channel (main lobe) corresponds to the transmission channel band TCB. Typically, the transmission channel band TCB is prescribed beforehand by a frequency rule or the like. A frequency band adjacent to the transmission channel band TCB (side lobe), is a leakage band LB. The power spectrum density in the leakage band LB must be reduced by a certain level or more than the power spectrum density in the transmission channel band TCB.

According to the present embodiment, the carrier sense band CS for the carrier sense processing is extended to be wider than the conventional transmission channel band TCB. In other words, the carrier sense band CS is set so as to include not only the transmission channel band TCB but also at least a part of the leakage band LB adjacent to the transmission channel band TCB. As shown in FIG. 10, the carrier sense band CS is set so as to include the “center carrier sense band CSC” and the “adjacent carrier sense band CSA”. The center carrier sense band CSC is the same as the transmission channel band TCB, and corresponds to a conventional carrier sense band. The adjacent carrier sense band CSA is adjacent to the center carrier sense band CSC and includes at least a part of the leakage band LB. Typically, the adjacent carrier sense bands CSA are provided on both left and right sides of the center carrier sense band CSC on the frequency axis.

As described above, according to the present embodiment, the carrier sense band CS for the carrier sense processing is set so as to include not only the transmission channel band TCB but also the adjacent carrier sense band CSA adjacent to the transmission channel band TCB. Thus, interference received by the wireless communication device 10 from the other wireless communication device and interference given by the wireless communication device 10 to the other wireless communication device are suppressed. As a result of the interference suppression, communication quality in the wireless communication systems 1, 2 is improved.

### 2-2. Example of Processing Flow

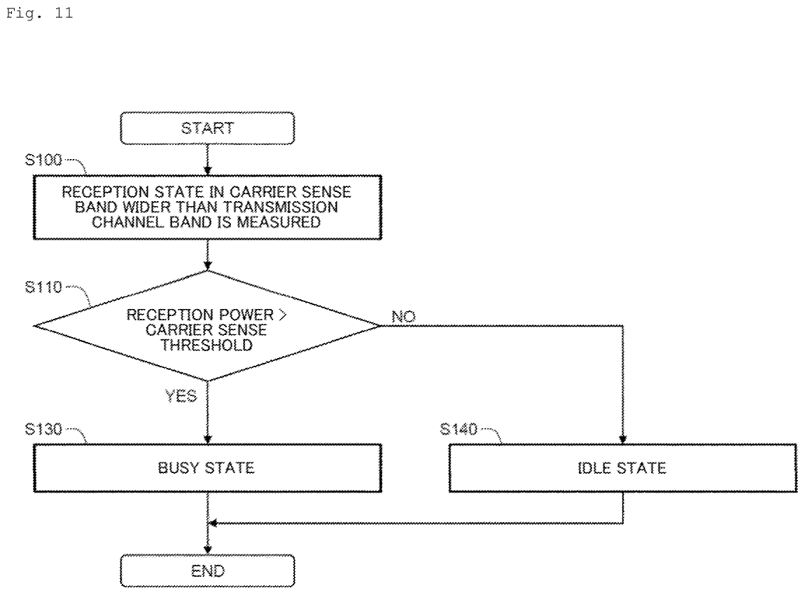

FIG. 11 is a flowchart illustrating an example of the carrier sense processing according to the present embodiment. The wireless communication device 10 measures a reception state of a reception signal in a carrier sense band CS wider than a transmission channel band TCB for a fixed time before starting signal transmission (step S100). Subsequently, the wireless communication device 10 compares the received power with a carrier sense threshold TH (step S110). When the received power exceeds the carrier sense threshold TH, the wireless communication device 10 determines that the carrier sense band CS is in a busy state (step S130). On the other hand, when the reception power is equal to or less than the carrier sense threshold TH (step S110; No), the wireless communication device 10 determines that the carrier sense band CS is in an idle state (step S140).

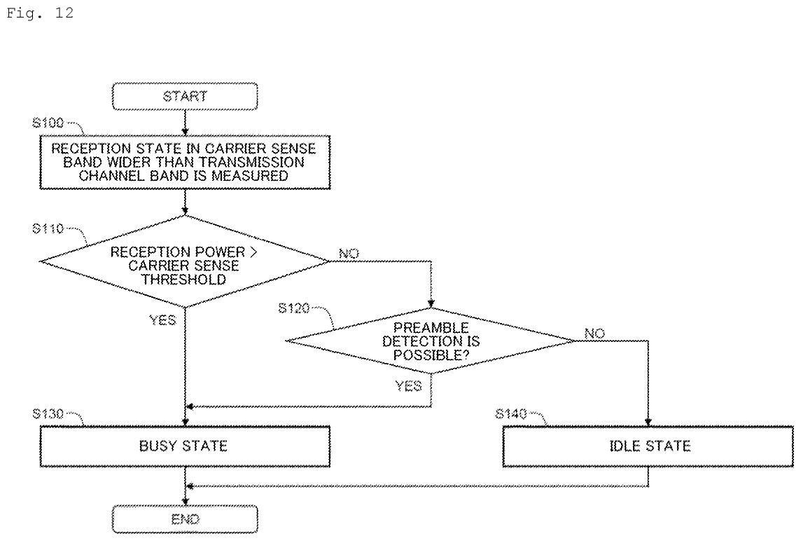

FIG. 12 is a flowchart illustrating another example of the carrier sense processing according to the present embodiment. Steps S100, S110, and S130 are the same as the example showed in FIG. 11. When the reception power is equal to or less than the carrier sense threshold TH (step S110; No), the wireless communication device 10 determines whether or not a preamble at the head of the Wireless LAN frame can be detected (step S120). The preamble is required for synchronization processing or the like. When the preamble can be detected (step S120; Yes), the wireless communication device 10 determines that the carrier sense band CS is in a busy state (step S130). On the other hand, when the preamble is not detectable (step S120; No), the wireless communication device 10 determines that the carrier sense band CS is in an idle state (step S140).

### 2-3. An Example of a Carrier Sense Band

Some examples of the carrier sense band CS according to the present embodiment will be described below.

### 2-3-1. First Example

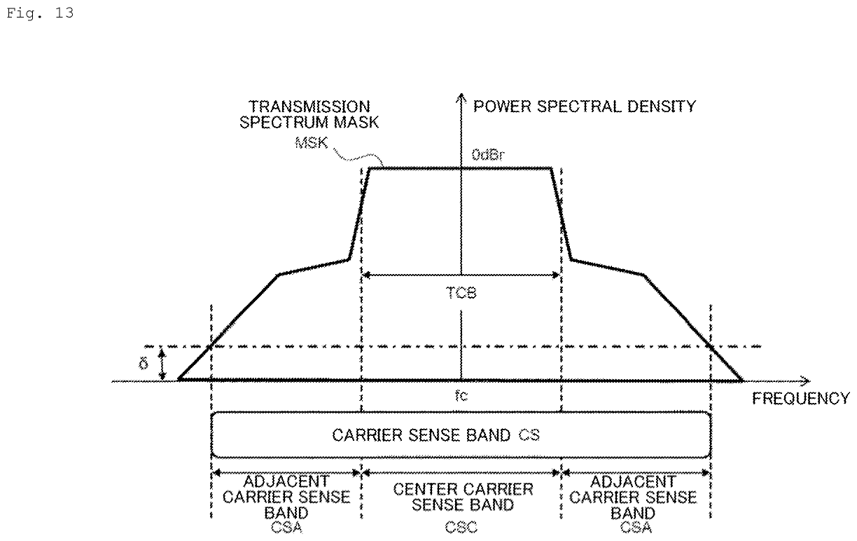

FIG. 13 is a conceptual diagram for explaining a first example of the carrier sense band CS. In the first example, the adjacent carrier sense band CSA is set so as to include a frequency band in which leakage power density (interference power density) caused by a transmission signal are equal to or higher than a predetermined value δ. The leakage power density is predicted from a transmission spectrum mask MSK used in the wireless communication system 1 or a transmission power density of a transmission signal.

For example, the predetermined value δ is a value which is lower than the power density of the transmission channel band TCB (power spectrum density) by a constant level (i.e. 30 dB).

As another example, the predetermined value δ is the adjacent channel leakage power density defined by the frequency rule. For example, an adjacent channel leakage power density defined by a frequency rule in a 920 MHz band in Japan is −36 dBm/100 kHz. In this case, −36 dBm/100 kHz is used as a prescribed value δ.

According to the first example, it is possible to prevent the carrier sense band CS (adjacent carrier sense band CSA) from becoming unnecessarily wide, while sufficiently suppressing interference. In other words, the carrier sense rule is prevented from becoming unnecessarily severe.

### 2-3-2. Second Example

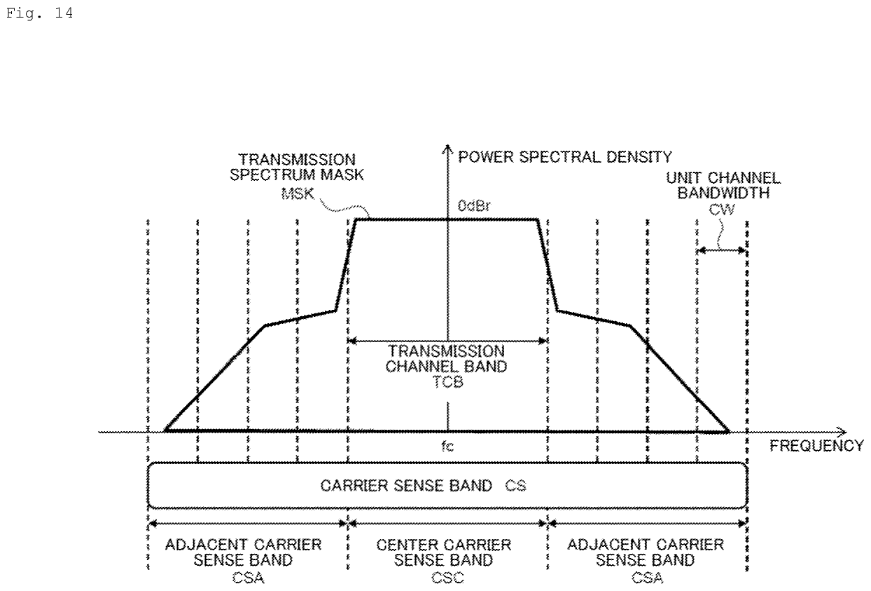

FIG. 14 is a conceptual diagram for explaining a second example of the carrier sense band CS. In the second example, the adjacent carrier sense band CSA is set in units of channel divisions defined by frequency rules and standard standards. That is, the bandwidth of the adjacent carrier sense band CSA is an integer multiple of the unit channel bandwidth CW defined in the wireless communication system 1.

Alternatively, the bandwidth of the adjacent carrier sense band CSA is an integer multiple of the unit channel bandwidth CW prescribed in another wireless communication system 2 using the same frequency band as that of the wireless communication system 1.

The combination of the first and second examples is as follows. That is, the adjacent carrier sense band CSA is set so as to include a frequency band of a channel in which the leakage power density (interference power density) are equal to or higher than a predetermined value δ. Thus, it is possible to prevent the carrier sense band CS (adjacent to the carrier sense band CSA) from becoming unnecessarily wide, while sufficiently suppressing interference.

### 2-3-3. Third Example

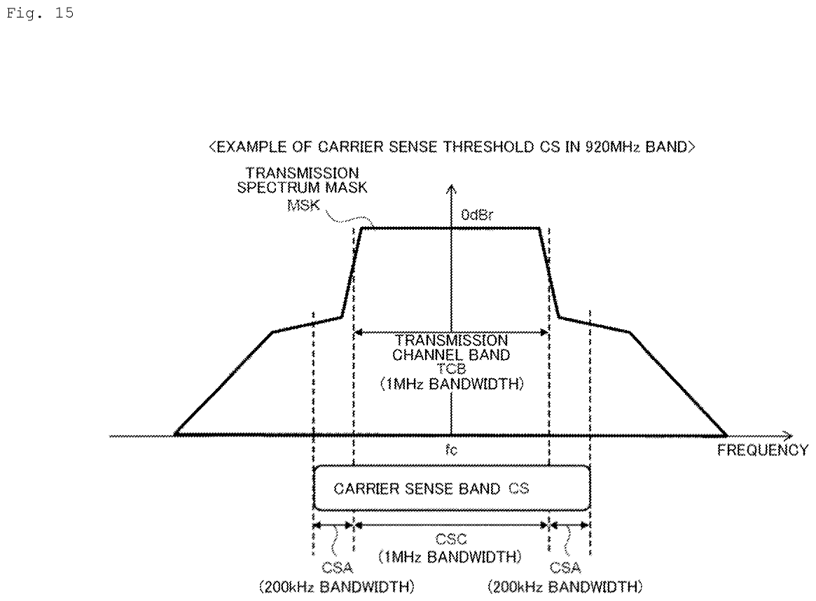

FIG. 15 is a conceptual diagram for explaining a third example of the carrier sense band CS. In the third example, especially the 920 MHz band is considered. In a 920 MHz band in Japan, channels are partitioned at every 200 kHz. In IEEE802.11ah, the minimum channel width is 1 MHz. Therefore, a transmission channel of 1 MHz width obtained by bundling five channels is used.

As shown in FIG. 15, the adjacent carrier sense band CSA is set so as to have a bandwidth of 200 kHz on each of the left and right sides of the transmission channel band TCB on the frequency axis. That is, for a transmission channel band TCB having a width of 1 MHz, a carrier sense band CS having a width of 1.4 MHz is applied. Thus, it is considered that even if leakage power occurs, signal collision can be sufficiently avoided and wireless communication characteristics can be improved. When it is generalized more, the adjacent carrier sense band CSA may be set to have a bandwidth of an integer multiple of 200 kHz.

### 2-3-4. Fourth Example

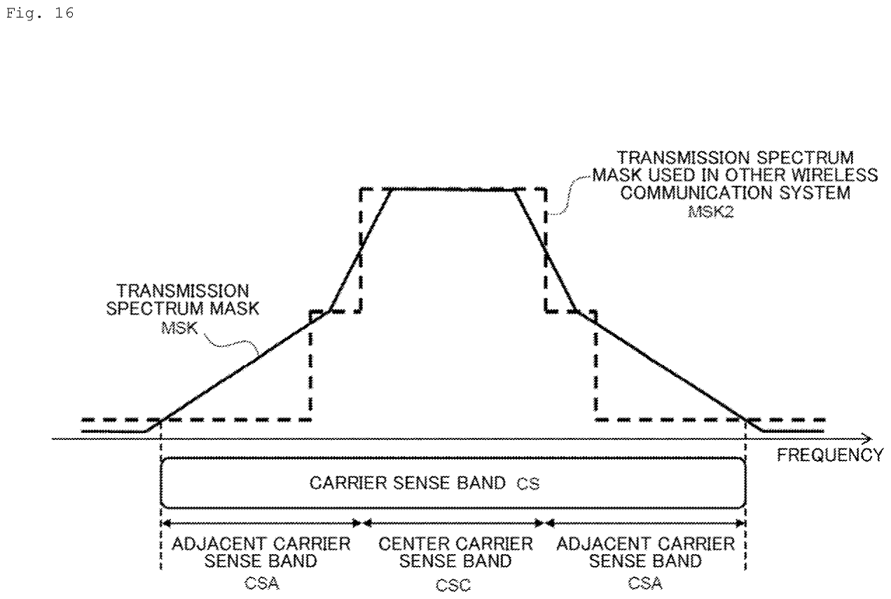

FIG. 16 is a conceptual diagram for explaining a fourth example of the adjustment of access parameters. In the fourth example, a transmission spectrum mask MSK2 used in another wireless communication system 2 using the same frequency band as the wireless communication system 1 is taken into consideration. Specifically, the adjacent carrier sense band CSA is set so as to include all frequency bands in which a transmission spectrum mask MSK used in the wireless communication system 1 is higher than a transmission spectrum mask MSK2 used in the other wireless communication system 2. Thus, it is possible to prevent the carrier sense band CS (adjacent to the carrier sense band CSA) from becoming unnecessarily wide, while sufficiently suppressing interference.

### 2-4. An Example of a Carrier Sense Threshold

Some examples of the carrier sense threshold TH will be described below.

### 2-4-1. First Example

In a first example, the carrier sense threshold TH is set so as to be equal to a conventional carrier sense threshold. The conventional carrier sense threshold is, for example, −62 dBm per 20 MHz bandwidth.

### 2-4-2. Second Example

It may be considerable that the reception power is increased as the carrier sense band CS becomes wider than the conventional transmission channel band TCB. Therefore, in a second example, the carrier sense threshold TH is set (corrected) so as to be higher than the conventional carrier sense threshold.

Note that, when the wireless filter forming the transmission signal spectrum is used also at the time of reception, the reception signal intensity in the adjacent carrier sense band CSA is smaller than the reception signal intensity in the center carrier sense band CSC (transmission channel band TCB). In consideration of the frequency characteristics of such a radio filter, it is not necessary to increase the carrier sense threshold TH more than necessary. That is, although the bandwidth of the carrier sense band CS is expanded to X times as large as the conventional one, it is not necessary to increase the carrier sense threshold TH to X times as large as the conventional one. The carrier sense threshold TH is set to an appropriate value in consideration of a ratio of a frequency band in which the reception signal intensity is reduced due to non-uniform frequency characteristics of the wireless filter.

### 2-4-3. Third Example

When an interference signal from another wireless communication device is included in a reception signal received by the wireless communication device 10, the SINR (Signal to Noise Interference Ratio) of the reception signal deteriorates. If it is assumed that the transmission power of the wireless communication device 10 and the wireless communication device of the interference partner are the same, it is considered that the same SINR is detected also in the wireless communication device of the interference partner.

From this viewpoint, in the third example, the carrier sense threshold TH is set to interference power such that an error rate assumed at the time of signal reception in the wireless communication device 10 is equal to or less than a predetermined value.

For example, assume multi-level modulation with the closest distance between signal points (worst error rate characteristics). In the case of that multi-level modulation, the SINR at which the error rate (e.g., Bit Error Rate (BER)) is a predetermined value (e.g., 10-3) is calculated. The correspondence relation among the modulation system, the SINR, and the error rate is obtained from a map prepared in advance, for example. The interference power in the case of the SINR is the upper limit value of the allowable interference power and is used as a carrier sense threshold TH. That is, the carrier sense threshold TH is set to interference power so that an assumed error rate is equal to or less than a predetermined value.

### 3. Divided Carrier Sense Processing

### 3-1. Outline

The carrier sense band CS according to the present embodiment may be divided into a plurality of divided carrier sense bands Cs-i (i=1 to n). Here, n is an integer greater than or equal to 2.

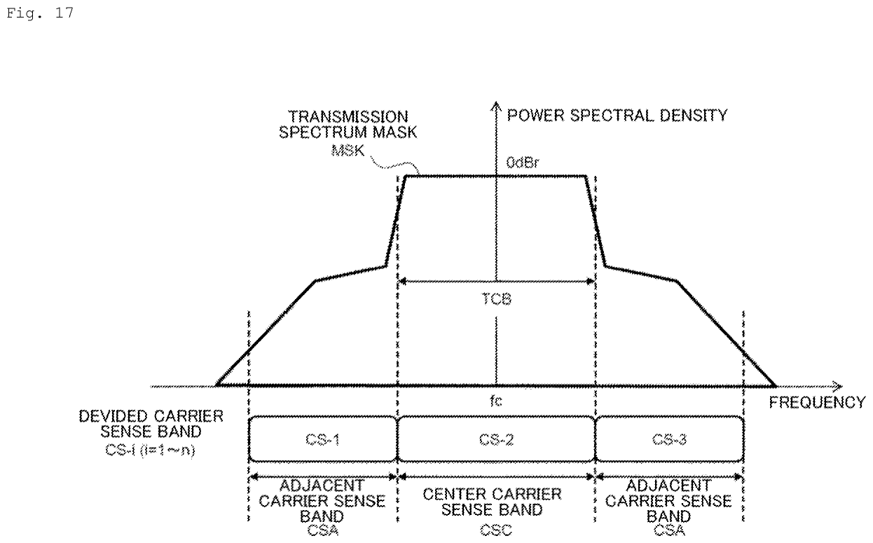

For example, in FIG. 17, the carrier sense band CS is divided into three divided carrier sense bands CS-1 to CS-3. The divided carrier sense band CS-1 corresponds to an adjacent carrier sense band CSA adjacent to the left side of the center carrier sense band CSC on the frequency axis. The divided carrier sense band CS-2 corresponds to the center carrier sense band CSC. The divided carrier sense band CS-3 corresponds to an adjacent carrier sense band CSA adjacent to the right side of the center carrier sense band CSC on the frequency axis.

The carrier sense processing is performed independently for each divided carrier sense band CS-i. The carrier sense processing for each divided carrier sense band CS-i is hereinafter referred to as “divided carrier sense processing”. That is, the carrier sense processing as a whole includes a divided carrier sense processing for each divided carrier sense band CS-i. In the divided carrier sense processing, the wireless communication device 10 determines whether the divided carrier sense band CS-i is in a busy state or in an idle state on the basis of a reception state of a reception signal in the divided carrier sense band CS-i. Then, the wireless communication device 10 integrates the results of the divided carrier sense processing for the plurality of divided carrier sense bands CS-i to determine whether the carrier sense band CS as a whole is in a busy state or in an idle state.

In this way, when the carrier sense band CS is divided into the plurality of divided carrier sense bands Cs-i, different carrier sense rules can be independently applied to each of the plurality of divided carrier sense bands CS-i. That is, the degree of freedom and flexibility of the carrier sense processing are improved. Thus, the carrier sense processing can be more appropriately performed in accordance with the situation and the regulations to be observed by each divided carrier sense band CS-i.

### 3-2. Example of Processing Flow

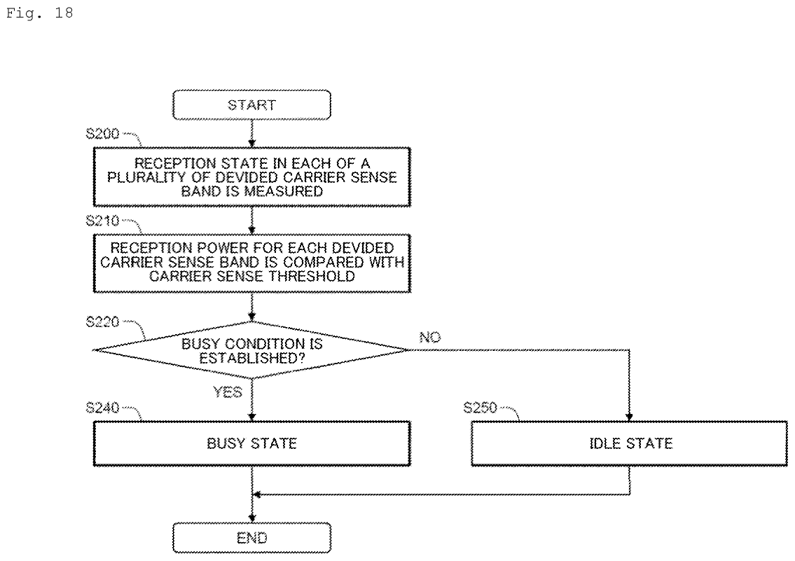

FIG. 18 is a flow chart showing an example of the carrier sense processing including the divided carrier sense processing.

The wireless communication device 10 performs divided carrier sense processing to each of the plurality of divided carrier sense bands CS-i (i=1 to n). Specifically, the wireless communication device 10 measures the reception state of the reception signal in each divided carrier sense band CS-i for a fixed time period (step S200). Subsequently, the wireless communication device 10 compares the received power with a carrier sense threshold TH(i) for each divided carrier sense band CS-i (step S210). The carrier sense threshold TH(i) is independently set for each divided carrier sense band CS-i. When the reception power exceeds the carrier sense threshold TH(i), the wireless communication device 10 determines that the divided carrier sense band CS-i is in a busy state. On the other hand, when the received power is equal to or less than the carrier sense threshold TH(i), the wireless communication device 10 determines that the divided carrier sense band CS-i is in an idle state.

Subsequently, the wireless communication device 10 integrates results of divided carrier sense processing for the plurality of divided carrier sense bands CS-i, and determines whether a “busy condition” or an “idle condition” is established (step S220). The busy condition is a condition for determining that the carrier sense band CS as a whole is in a busy state. On the other hand, the idle condition is a condition for determining that the carrier sense band CS as a whole is in an idle state.

For example, the idle condition is that all of a plurality of divided carrier sense bands CS-i are in an idle state. The busy condition is that the idle condition is not established. That is, the busy condition is that at least one of the plurality of divided carrier sense bands CS-i is in a busy state.

As another example, the idle condition is that a specific divided carrier sense band CS-j of the plurality of divided carrier sense bands CS-i is in an idle state, and a certain ratio or more of the divided carrier sense bands CS-k other than the specific divided carrier sense band CS-j is in an idle state. For example, a specific divided carrier sense band CS-j overlaps with a transmission channel band TCB (center carrier sense band CSC). In this case, the idle condition is that a specific divided carrier sense band CS-j overlapping the transmission channel band TCB is in an idle state, and that a fixed ratio (e.g., 50%) or more of the divided carrier sense band CS-k corresponding to the adjacent carrier sense band CSA is in an idle state. The busy condition is that the idle condition is not established.

When the busy condition is established (step S220; Yes), the wireless communication device 10 determines that the carrier sense band CS as a whole is in a busy state (step S240). On the other hand, when the idle condition is established (step S220; No), the wireless communication device 10 determines that the carrier sense band CS as a whole is in an idle state (step S250).

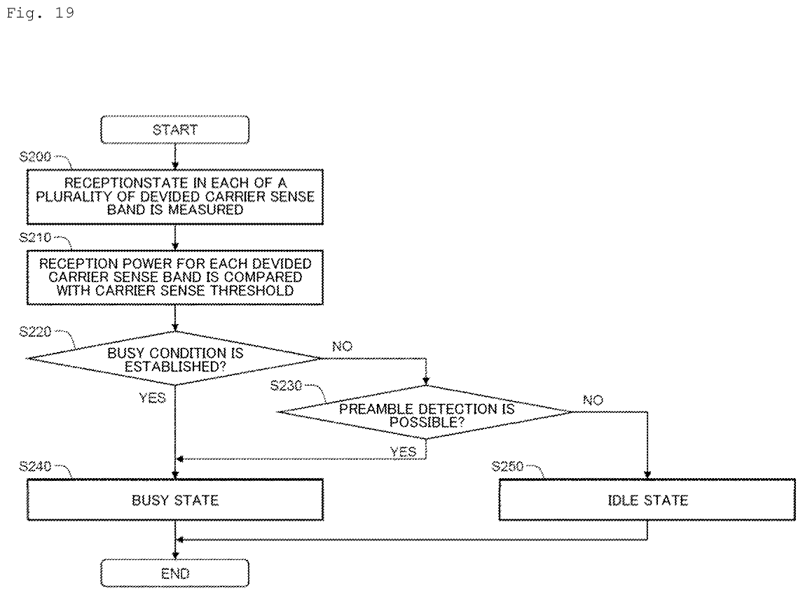

FIG. 19 is a flowchart showing another example of the carrier sense processing including the divided carrier sense processing. Steps S200, S210, S220, S240 are the same as the steps showed in the example of FIG. 18. When the busy condition is not established (step S220; No), the wireless communication device 10 determines whether or not the preamble of the top of the Wireless LAN frame can be detected (step S230). When the preamble can be detected (step S230; Yes), the wireless communication device 10 determines that the carrier sense band CS is in a busy state (step S240). On the other hand, when the preamble is not detectable (step S230; No), the wireless communication device 10 determines that the carrier sense band CS is in an idle state (step S250).

### 3-3. An Example of a Divided Carrier Sense Band

Some examples of the divided carrier sense band CS-i will be described below.

### 3-3-1. First Example

In a first example, as shown in FIG. 17, the carrier sense band CS is divided into a central carrier sense band CSC (transmission channel band TCB) and adjacent carrier sense bands CSA. That is, the plurality of divided carrier sense bands CS-i include a center carrier sense band CSC and adjacent carrier sense bands CSA. In this case, not only one uniform carrier sense rule but different carrier sense rules can be applied independently to the center carrier sense band CSC and the adjacent carrier sense band CSA.

For example, it is possible that the frequency rules may be different inside and outside the transmission channel band TCB. In this case, carrier sense rules according to respective frequency rules are applied to the center carrier sense band CSC and the adjacent carrier sense band CSA.

Further, the transmission power in the adjacent carrier sense band CSA is smaller than the transmission power in the center carrier sense band CSC and the transmission channel band TCB, and the degree of interference given to other wireless communication devices is relatively small. Thus, carrier sense rules for adjacent carrier sense bands CSA may be relaxed more than carrier sense rules for central carrier sense bands CSC. Thus, the carrier sense rule can be prevented from becoming unnecessarily severe while sufficiently suppressing interference.

### 3-3-2. Second Example

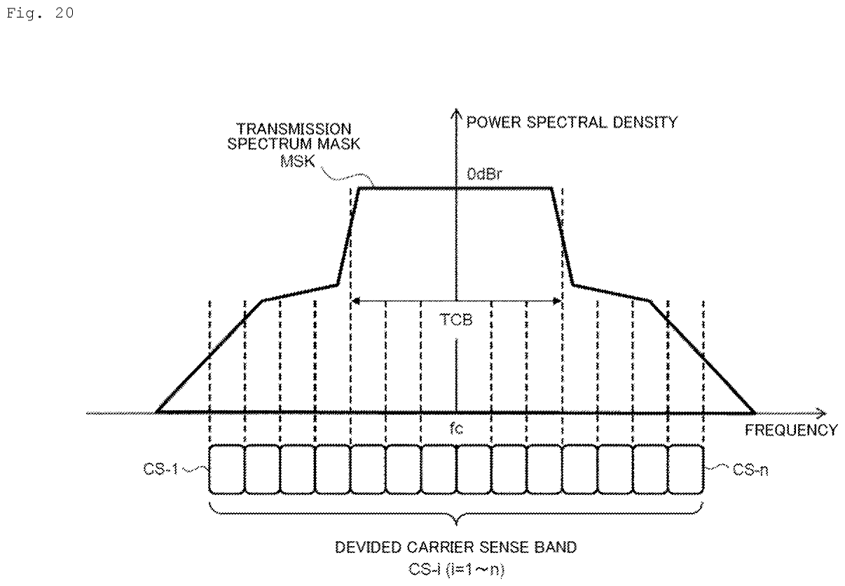

FIG. 20 is a conceptual diagram for explaining a second example of the divided carrier sense band CS-i. In the second example, the bandwidth of each divided carrier sense band CS-i is narrower than the bandwidth of the transmission channel band TCB. Further, the plurality of divided carrier sense bands CS-i do not overlap each other but are continuous on the frequency axis. By using such fine divided carrier sense band CS-i, more precise carrier sense processing can be performed.

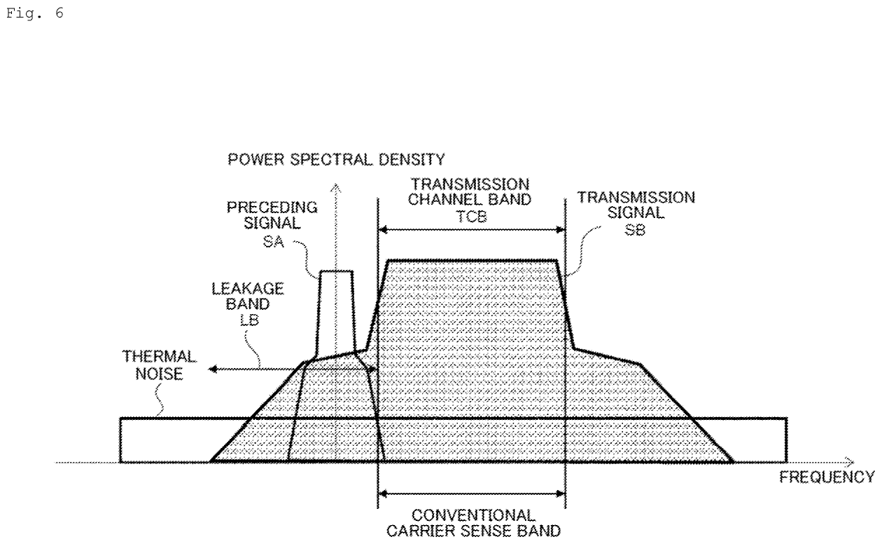

For example, in FIG. 6, the preceding signal SA and the transmission signal SB which coexist in the same frequency band are wireless signals according to different wireless communication standards. For example, the preceding signal SA is a Wireless LAN signal using a 920 MHz band in accordance with IEEE 802.11ah. The bandwidth of the transmission spectrum of the preceding signal SA is relatively narrow, and the bandwidth of the transmission spectrum of the transmission signal SB is relatively wide. In such a situation, it is assumed that a wide carrier sense band CS is used as a comparative example. In the case of the comparative example, the reception power caused by the preceding signal SA is averaged over a wide carrier sense band CS, and there is a possibility that the carrier sense band CS is determined to be in an idle state. On the other hand, when a fine divided carrier sense band CS-i shown in FIG. 20 is used, the divided carrier sense band CS-i in which the preceding signal SA exists is highly likely to be determined to be busy. That is, by using the fine divided carrier sense band CS-i, more precise carrier sense processing can be performed.

### 3-3-3. Third Example

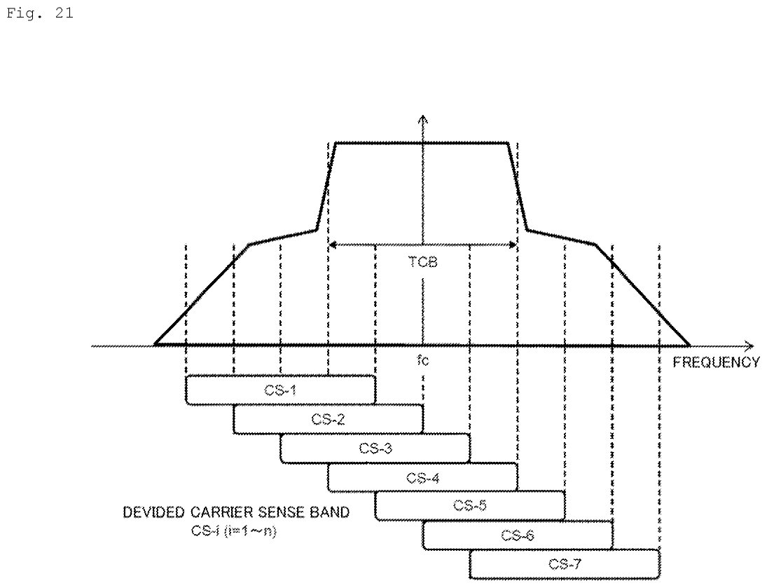

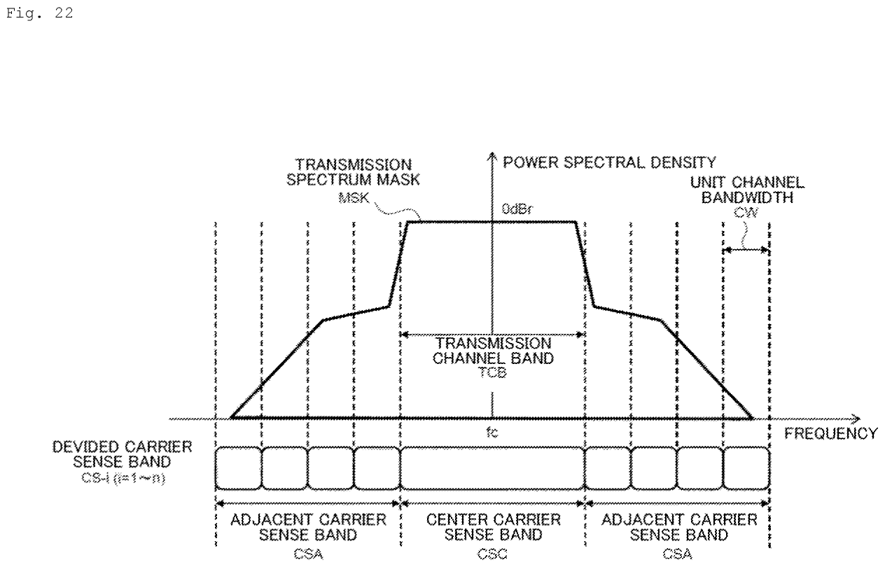

FIG. 21 is a conceptual diagram for explaining a third example of the divided carrier sense band CS-i. In the third example, the plurality of divided carrier sense bands CS-i are partially overlapped. More specifically, the plurality of divided carrier sense bands CS-i are shifted in order on the frequency axis. The divided carrier sense bands CS-i adjacent to each other on the frequency axis partially overlap each other. The bandwidth of the plurality of divided carrier sense bands CS-i may be the same. By using such partially overlapping divided carrier sense bands CS-i, more precise carrier sense processing can be performed.

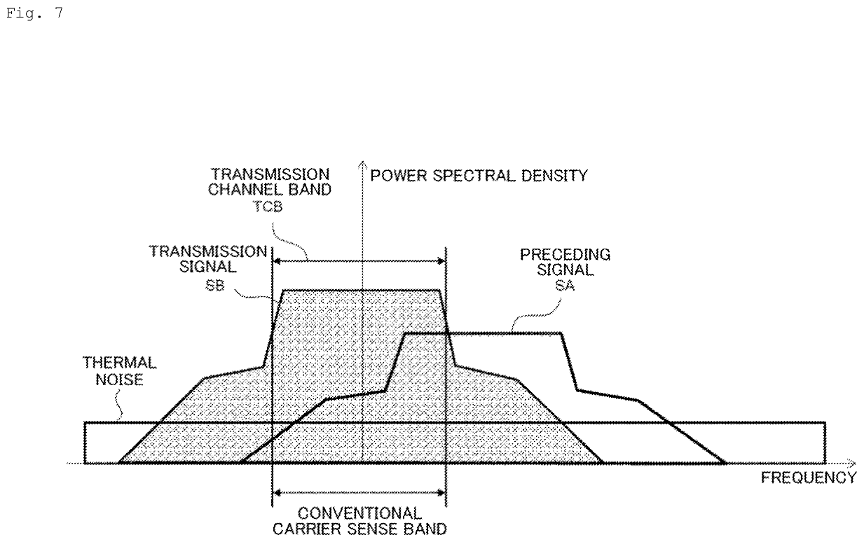

For example, in FIG. 7, the transmission channel band TCB of the transmission signal SB and the transmission channel band of the preceding signal SA partially overlap each other. In such a situation, it is assumed that a wide carrier sense band CS is used as a comparative example. In the case of the comparative example, the carrier sense band CS may be determined to be in an idle state depending on the overlap ratio or the transmission power of the preceding signal SA. In addition, partial overlap of the transmission channel band TCB of the transmission signal SB and the preceding signal SA cannot be identified. On the other hand, when the divided carrier sense band CS-i shown in FIG. 21 is used, the divided carrier sense band CS-i existing at the center of the overlapping portion is highly likely to be determined to be busy. Further, it is possible to identify even a partial overlap of the transmission channel band TCB of the transmission signal SB and the preceding signal SA. That is, more precise carrier sense processing can be performed.

### 3-3-4. Fourth Example

FIG. 22 is a conceptual diagram for explaining a fourth example of the divided carrier sense band CS-i. As in the case of FIG. 14, the adjacent carrier sense band CSA is set in units of channel divisions defined by the frequency rules and standards. That is, the bandwidth of the adjacent carrier sense band CSA is an integer multiple of the unit channel bandwidth CW. The adjacent carrier sense band CSA is divided into divided carrier sense bands CS-i for each unit channel bandwidth CW. In other words, in the adjacent carrier sense band CSA, each divided carrier sense band CS-i has a unit channel bandwidth CW.

In the adjacent carrier sense band CSA, the carrier sense rule (carrier sense threshold TH(i)) for each divided carrier sense band CS-i is independently applied. For example, a carrier sense rule (carrier sense threshold Th(i)) which conforms to a frequency rule to be observed in each divided carrier sense band CS-i, is applied to each divided carrier sense band CS-i. Thus, more precise carrier sense processing can be performed.

### 3-4. An Example of a Carrier Sense Threshold for a Divided Carrier Sense Band

Several examples of the carrier sense threshold TH(i) for the divided carrier sense band CS-i will be described below.

### 3-4-1. First Example

The frequency rules of the frequency bands to which the plurality of divided carrier sense bands CS-i belong are not always the same. In a first example, the carrier sense threshold TH(i) is set according to the frequency rule of the frequency band to which the divided carrier sense band CS-i belongs.

For example, in FIG. 17, the carrier sense band CS is divided into a central carrier sense band CSC (transmission channel band TCB) and an adjacent carrier sense band CSA. When the frequency rules are different between the inside and the outside of the transmission channel band TCB, a carrier sense threshold TH(i) according to each frequency rule is applied to the center carrier sense band CSC and the adjacent carrier sense band CSA.

### 3-4-2. Second Example

In a second example, a carrier sense threshold TH(i) for the divided carrier sense band CS-i is set in consideration of transmission power assumed in the divided carrier sense band CS-i. The transmission power in the divided carrier sense band CS-i can be estimated from a numerical value related to the transmission spectrum mask MSK or the antenna power at the time of transmission.

More specifically, when the transmission power assumed in the divided carrier sense band CS-i is small, the degree of interference of the transmission signal in the divided carrier sense band CS-i to the other wireless communication device is relatively small. Therefore, as the transmission power assumed in the divided carrier sense band CS-i becomes smaller, the carrier sense threshold TH(i) for the divided carrier sense band CS-i is set so as to be higher. That is, as the transmission power assumed in the divided carrier sense band CS-i becomes smaller, the carrier sense rule for the divided carrier sense band CS-i is relaxed. Thus, the carrier sense rule can be prevented from becoming unnecessarily severe while sufficiently suppressing interference.

The transmission power in the transmission channel band TCB is Ptx[dBm], the bandwidth of the transmission channel band TCB is Btx[MHz], the carrier sense threshold in the transmission channel band TCB is THtx[dBm], and the transmission power in the divided carrier sense band CS-i is p(i) [dBm], and the band of the divided carrier sense band CS-i is B(i)[MHz]. In this case, for example, the carrier sense threshold TH(i)[dBm] for divided carrier sense band CS-i is shown in next expression (1).

Th(i)=THtx+α(Ptx/Btx−P(i)/B(i)) <Expression (1)>

The α in the equation (1) Is a positive coefficient. The carrier sense threshold value TH(i) may be provided with an upper limit value and a lower limit value. Further, the carrier sense threshold Th(i) does not need to necessarily change linearly.

### 3-4-3. Third Example

The third example is similar to an explained example in already sent section 2-4-3. With respect to each divided carrier sense band CS-i, the carrier sense threshold TH(i) is set to interference power so that an error rate assumed at the time of signal reception in the wireless communication device 10 is equal to or less than a predetermined value.

For example, assume multi-level modulation with the closest distance between signal points (worst error rate characteristics). In the case of that multi-level modulation, the SINR at which the error rate (e.g., Bit Error Rate (BER)) is a predetermined value (e.g., 10-3) is calculated. The correspondence relation among the modulation system, the SINR, and the error rate is obtained from a map prepared in advance, for example. The interference power in the case of the SINR is the upper limit value of the allowable interference power and is used as a carrier sense threshold TH(i). That is, the carrier sense threshold TH(i) is set to such an interference power that an assumed error rate is equal to or less than a predetermined value.

### 4. Others

Unless contradictory, a plurality of combinations of the various examples described above are also possible.

### REFERENCE SIGNS LIST

1 Wireless communication system
10 Communication device
11 Communication processing unit
12 Carrier sense control unit
13 Communication processing unit
CS carrier sense band
CSA adjacent carrier sense band
CSC center carrier sense band
Cs-i divided carrier sense band
LB leakage band
MSK transmission spectrum mask
TCB transmission channel band

1. A wireless communication method in a wireless communication system comprising:
a carrier sense processing in which it is determined whether a carrier sense band is in a busy state or an idle state based on a reception state of a reception signal in the carrier sense band before transmitting a transmission signal using a transmission channel;
and transmission processing in which a transmission signal is transmitted by using the transmission channel when it is determined that the carrier sense band is in the idle state;
wherein the carrier sense band is set so as to include not only a transmission channel band which is a frequency band of the transmission channel but also an adjacent carrier sense band adjacent to the transmission channel band.

2. The wireless communication method according to claim 1,
wherein
the adjacent carrier sense band is set so as to include a frequency band in which leakage power density predicted from a transmission spectrum mask used in the wireless communication system or transmission power density of the transmission signal is equal to or more than a predetermined value.

3. The wireless communication method according to claim 1,
wherein
the bandwidth of the adjacent carrier sense band is an integer multiple of a unit channel bandwidth defined in the wireless communication system or another wireless communication system using the same frequency band as the wireless communication system.

4. The wireless communication method according to claim 1,
wherein
the wireless communication system uses a 920 MHz band,
the adjacent carrier sense band is set so as to have a bandwidth of an integer multiple of 200 kHz on each of the right and left sides of the transmission channel band on a frequency axis.

5. The wireless communication method according to claim 1,
wherein
the adjacent carrier sense band is set so that a transmission spectrum mask used in the wireless communication system includes a frequency band higher than a transmission spectrum mask used in another wireless communication system using the same frequency band as the wireless communication system.

6. The wireless communication method according to claim 1, wherein
the carrier sense band is divided into a plurality of divided carrier sense bands,
the carrier sense processing includes divided carrier sense processing for determining whether each of the plurality of divided carrier sense bands is in the busy state or in the idle state on the basis of the reception state of the reception signal in each of the plurality of divided carrier sense bands.

7. The wireless communication method according to claim 6,
wherein
the divided carrier sense processing for each of the plurality of divided carrier sense bands includes a processing of comparing a received power of the received signal in each of the plurality of divided carrier sense bands with a carrier sense threshold, the carrier sense threshold is set independently for each of the plurality of divided carrier sense bands.

8. The wireless communication method according to claim 7,
wherein
the carrier sense threshold value for each of the plurality of divided carrier sense bands is set so as to be higher as the transmission power of the transmission signal assumed in each of the plurality of divided carrier sense bands becomes smaller.

9. The wireless communication method according to claim 6, wherein
the carrier sense band is divided into the transmission channel band and the adjacent carrier sense band.

10. The wireless communication method according to claim 6,
wherein a bandwidth of each of the plurality of divided carrier sense bands is narrower than a bandwidth of the transmission channel band,
the plurality of divided carrier sense bands do not overlap each other and are continuous on a frequency axis.

11. The wireless communication method according to claim 6,
the plurality of divided carrier sense bands are sequentially shifted on a frequency axis so that adjacent divided carrier sense bands partially overlap each other.

12. The wireless communication method according to claim 6,
wherein the bandwidth of the adjacent carrier sense band is an integer multiple of a unit channel bandwidth defined in the wireless communication system or another wireless communication system using the same frequency band as the wireless communication system,
the adjacent carrier sense band is divided into divided carrier sense bands for each unit channel bandwidth.

13. The wireless communication method according to claim 6, wherein
the carrier sense processing includes processing for determining that the carrier sense band is in the idle state when it is determined that all of the plurality of divided carrier sense bands are in the idle state.

14. The wireless communication method according to claim 6, wherein
the carrier sense processing includes processing for determining that the carrier sense band is in the idle state when it is determined that a specific divided carrier sense band out of the plurality of divided carrier sense bands is in the idle state and it is determined that a fixed rate or more of divided carrier sense bands other than the specific divided carrier sense band is in the idle state.

15. A wireless communication device in a wireless communication system comprising:
a carrier sense processing unit configured to determine whether a carrier sense band is in a busy state or an idle state based on a reception state of a reception signal in the carrier sense band,
and a transmission processing unit for transmitting the transmission signal by using the transmission channel when it is determined that the carrier sense band is in the idle state, wherein the carrier sense processing unit sets the carrier sense band so as to include not only a transmission channel band that is a frequency band of the transmission channel but also an adjacent carrier sense band adjacent to the transmission channel band.
